(19) United States
(12) Patent Application Publication
(10) Pub. No.: US 2010/0326696 A1
(43) Pub. Date: Dec. 30, 2010

(54) LIQUID CRYSTAL POLYMER BLENDS FOR USE AS METAL WIRE INSULATION

(76) Inventor: AMARESH MAHAPATRA, ACTON, MA (US)

Correspondence Address: FRANCIS J. CAUFIELD, 6 APOLLO CIRCLE, LEXINGTON, MA, 02421-7025, US

(21) Appl. No.: 12/398,197

(22) Filed: Mar. 5, 2009

Related U.S. Application Data
(60) Provisional application No. 61/035,539, filed on Mar. 11, 2008.

(51) Int. Cl. H01B 3/30

(52) U.S. Cl. 174/110 SR

(57) ABSTRACT

An electrically conducting wire structure and a method for its manufacture where the wire structure has at least one elongated electrically conducting wire and a liquid crystal polymer and thermoplastic blended coating of insulation preferably formed by cross-head extrusion as a layer around the electrically conducting wire. An abrasion layer is preferably formed over the liquid crystal polymer coating to increase abrasion resistance, the elongated electrically conducting wire is selected from the group comprising copper, silver, tinned copper, aluminum, and conducting polymers, and the liquid crystal polymer material comprises a thermotropic thermoplastic.

### CROSS REFERENCE TO RELATED APPLICATION

This application claims the benefit of priority from U.S. Provisional Patent Application No. 61/035,539 filed on Mar. 11, 2008 in the name of Amaresh Mahapatra and entitled LIQUID CRYSTAL POLYMER BLENDS FOR USE AS METAL WIRE INSULATION, the entire contents of which are incorporated herein by reference.

### GOVERNMENT LICENSE RIGHTS

This invention was made with government support under US Navy SBIR Contract No. N68335-07-C-0297. The U.S. Government has certain rights in this invention.

### FIELD OF THE INVENTION

This invention relates to a method of fabricating insulated metal wires that can be used in high temperature environments, harsh chemical environments, salt-spray environments, and environments in which low flammability is a requirement. In particular, it relates to insulation applied to metal wires using blends of extruded liquid crystal polymers (LCPs) and other thermoplastic polymers. The blends are optimized to achieve desirable insulation and physical properties.

### BACKGROUND OF THE INVENTION

Commercial and military aircraft have stringent requirements for wire harnesses used on board for electrical connectivity. Wiring in these applications is subjected to high temperature, fuel vapors, and vibration, and degrades with time. Serious and potentially fatal errors occur due to degraded wiring. Replacing wiring routinely after a certain time is essential, but costly.

Hydrolysis is a potential problem for any insulation using aromatic polyimide (e.g. Kapton). Currently used wire harness technology introduced in 1993 and consisting of Teflon-Kapton-Teflon (TKT) composite tape has significant performance issues. Kapton-H has been replaced with Teflon-T (Dupont trade name OASIS, U.S. Pat. No. 5,104,966; also see U.S. Pat. No. 6,781,063 B2) which has reduced, but not eliminated the hydrolysis problem. Hydrolysis is a process by which prolonged exposure to moisture alters the composition of this insulation and diminishes its integrity (See FIG. 1 explained more fully hereinafter). Weakened insulation develops cracks. At high temperatures, current arcs between two cracks that have developed close together. Arcing causes the insulation to carbonize which further increases the probability of arcing. Often carbonization is so severe that arcing will set the insulation on fire and the carbononized length will act like a fuse so that the burn propagates down the harness, compromising entire sections of the harness (See FIG. 2 explained more fully hereinafter). This phenomenon is called arc-tracking.

Polymer materials are increasingly being used in a wide range of applications in marine and outdoor environments. Often PVC is used as insulation, with wire size varying from 16 AWG (0.050″ diameter) to 8 AWG (0.13″ diameter), and the wire can be used for internal wiring of electrical equipment, internal wiring of panels and meters and point to point wiring. The wire can be either stranded or single conductor.

Wiring used in marine applications, such as recreational watercraft, degrades with time from exposure to salt spray and vibration. Over a period of ten to fifteen years, the insulation essentially cracks and falls apart. Another failure mode is the gradual change in surface chemistry from moisture and contamination so that the surface goes from being hydrophobic to hydrophilic. The modified surface then permits the development of electrical arcing that leads to flashover and on-board fires.

Numerous organizations are developing and implementing new testing requirements to measure the flame propagation characteristics of tray cables and the toxic gases generated during combustion of wire and cable used in building plenums. The establishment of a new flame testing criteria for tray cables may eliminate some cable constructions presently permitted in cable tray. Introduction of new materials that either are more flame retardant, produce less smoke, or generate less corrosive or toxic gases will be needed to meet new regulations.

Therefore, there is a widespread need for new wiring insulation constructions that survive for tens of years in high temperature environments, harsh chemical environments, salt-spray environments and environments in which low flammability is a requirement. The solutions must also be cost effective.

Accordingly, it is a principal object of this invention to provide such new wiring insulation structures and methods and materials for fabricating them.

Other objects of the invention will be obvious and will appear hereinafter when the following detailed description is read in connection with the accompanying drawings.

### SUMMARY OF THE INVENTION

An electrically conducting wire structure and a method for its manufacture where the wire structure has at least one elongated electrically conducting wire and a liquid crystal polymer and thermoplastic blended coating of insulation preferably formed by cross-head extrusion as a layer around the electrically conducting wire. The thermoplastic has properties such that the blended coating has a strain break at least 5% larger than the liquid crystal polymer would have acting alone and is preferably a fluropolymer. The blended coating includes a compatabilizer to provide the blended coating as a reactive blend. An abrasion layer is preferably formed over the liquid crystal polymer coating to increase abrasion resistance, the elongated electrically conducting wire is selected from the group comprising copper, silver, tinned copper, aluminum, and conducting polymers, and the liquid crystal polymer material comprises a thermotropic thermoplastic.

### BRIEF DESCRIPTION OF THE DRAWINGS

The structure, operation, and methodology of the invention, together with other objects and advantages thereof, may best be understood by reading the detailed description in connection with the drawings in which each part has an assigned a label and/or numeral that identifies it wherever it appears throughout the various drawings and wherein:

FIG. 1a is a diagrammatic view of conducting wire having a crack in its insulation;

FIG. 1b is a diagrammatic view illustrating cracks in a wire harness that has been exposed to heat and humidity (Aircraft Wire Degradation Study, 2002);

FIG. 2 is diagrammatic rendering of a photograph illustrating arc tracking damage in a wire bundle (Linzey, W., 2006);

FIG. 3 is a typical stress vs. strain curve for 30 mil OD, 10 mil ID Vectra A950 LCP tube.

FIG. 4 is a diagrammatic plan view of a wire of diameter “d” bent through a 180° arc of inner radius “r”;

FIG. 5 is a graph showing tensile properties for TLCP/LDPE/compatibilizer blends as a function of screw speed to prepare the compatibilizer;

FIG. 6 is a graph showing tensile properties for TLCP/LDPE/compatibilizer blends as a function of extrusion temperature to prepare the compatibilizer;

FIGS. 7(a) and (b) are graphs showing, respectively, heating and cooling thermograms for (50/50) Vectra Z-Ethylene-co-acrylic acid ionomer blends for different mixing times at 300° C.: (a) 3 min; (b) 6 min; (d) 10 min;

FIG. 8 is a photograph of crucibles after heat exposure for (a) A430 Vectra and (b) A950 Vectra; and

FIG. 9 is a diagrammatic cross-section of a wire structure in accordance with the invention.

### DETAILED DESCRIPTION

This invention relates to a method of fabricating insulated metal wires that can be used in high temperature environments, harsh chemical environments, salt-spray environments, and environments in which low flammability is a requirement. In particular, it relates to insulation applied to metal wires using blends of extruded liquid crystal polymers (LCPs) and other thermoplastic polymers.

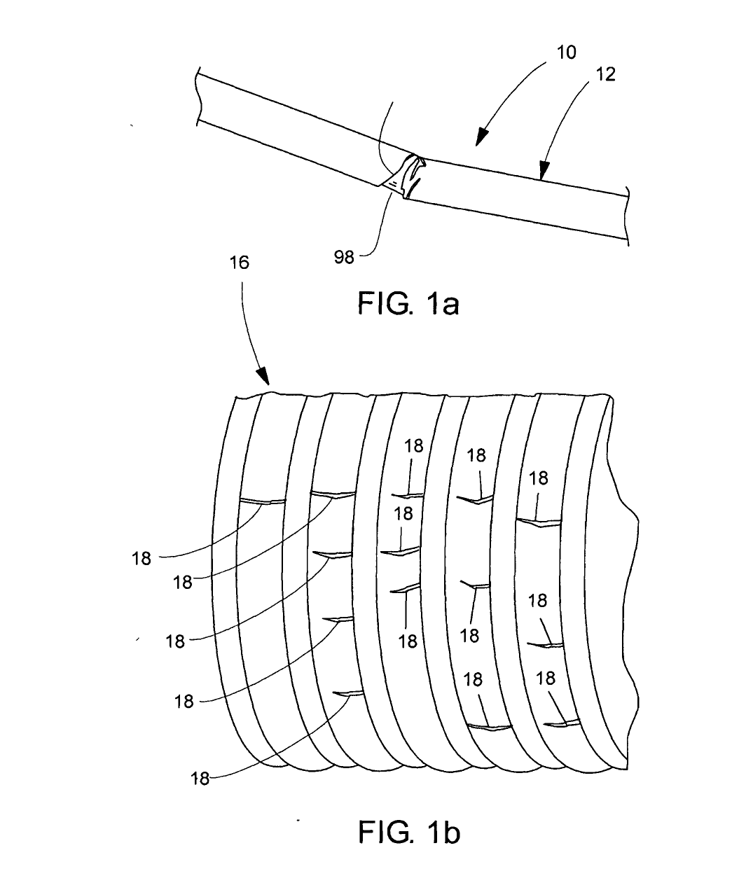

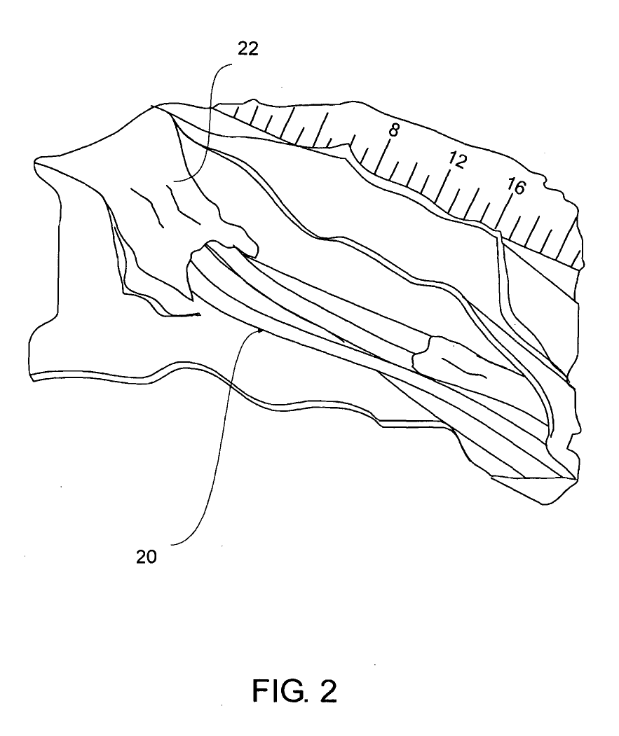

The invention addresses the problem of insulation cracking caused by hostile environments in which conducting wire structures are used. The results of exposure to such environments are illustrated in FIGS. 1a, 1b, and 2. As seen in FIG. 1a, there is shown a diagrammatic view of a conducting wire structure 10 having a crack in its insulation 12 exposing its internal conductor 14 thus permitting undesirable potential contact with its surroundings. FIG. 1b diagrammatically illustrates a wire harness 16 having cracks 18 caused by exposure to heat and humidity (Aircraft Wire Degradation Study, FAA Contract DTFA03-02-C-00040, 2002) with similar potential danger. FIG. 2 is diagrammatic rendering of a photograph illustrating actual arc tracking damage in a wire bundle with cracks (Linzey, W., McCutchan, M., and Traskos, M. “Evaluation of risk and possible mitigation schemes for previously unidentified hazards.” 9th Joint FAA/DoD/NASA 2006 Aging Aircraft Conference, March 6-9). To address these problems, blends of LCP and other thermoplastic polymers have been found beneficial.

Liquid crystal polymers (LCPs) are a new class of materials ideally suited for use as extruded wire harness insulation. LCP resins are commercially available from several major suppliers—Ticona, Allied Chemicals, Dupont and Sumitomo. LCPs have the following advantages:

a. No thermal degradation up to 450° C.; will meet 260° C. temperature rating (Jin, 1999).
b. Extremely low moisture absorption and transmission. No hydrolysis problem even at elevated temperatures.
c. Excellent chemical stability—no effect of immersion for prolonged periods in organic solvents, sulfuric acid, chromic acid, aviation fuels.
d. Tensile strength comparable to Kevlar.
e. LCP can be extruded on metal wires using conventional screw type extruders, and, therefore, cost much less than tape construction.
f. Laser markable (Haack, 1993).

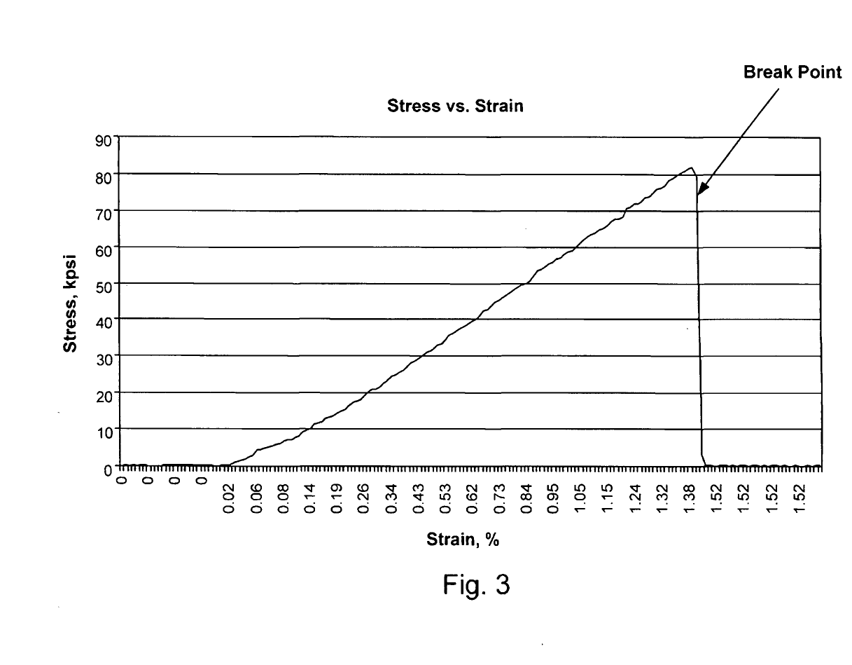

We have measured the tensile properties of extruded tubes of A950 Vectra grade LCP with an OD and ID of 0.03″ and 0.01″, respectively. A typical stress vs. strain curve is shown in FIG. 3. Note that the curve is fairly linear, the stress at break and strain at break are 80 kpsi and 1.5%, respectively. This corresponds to a tensile modulus of 5333 kpsi or 36 Gpa, which compares favorably with the tensile modulus of a hard ceramic like silica, which has a modulus of 70 GPa.

Table 1 compares the tensile strength (which is the same as stress at break) and strain at break for some thermoplastics that are used in wiring insulation compared against LCP. Vectra A950 LCP has the highest tensile strength, which is a desirable property for insulating materials. However, the strain at break strain is smaller, which may result in lack of flexibility.

TABLE 1
Comparison of tensile strength and strain
at break for some thermoplastics

| | Tensile | | |
|---|---|---|---|
| | Strength | Strain at | Melting Point |
| Thermoplastic | (MPa) | break (%) | (° C.) |
| Vectra A950 LCP | 547 | 2 | 280 |
| PFA | 29 | 300 | 360-240 |
| (Perfluoroalkoxyethylene) | | | |
| FEP (Fluorinated | 14 | 150 | 360-240 |
| Ethylene Propylene) | | | |
| Kapton | 221 | 80 | NA |
| (Thermoset, Polyimide) | | | |
| ETFE (Melt processible | 41 | 300 | 255-280 |
| fluoropolymer | | | |

Insulation for wire harness must pass qualification testing in accordance with aerospace standards document SAE AS4372 entitled “Performance Requirements for Wire, Electric, Insulated Copper or Copper Alloy.” One of the tests relates to “Flex Life”, which determines the ability of insulated wire to withstand repeated mechanical flexing. The test is performed with 22 gauge wire (≈30 mil diameter). The wire is put under tension and wound and unwound repeatedly through 180° around a mandrel with a diameter that is six times the diameter of the wire. The number of cycles for the wire to break is determined.

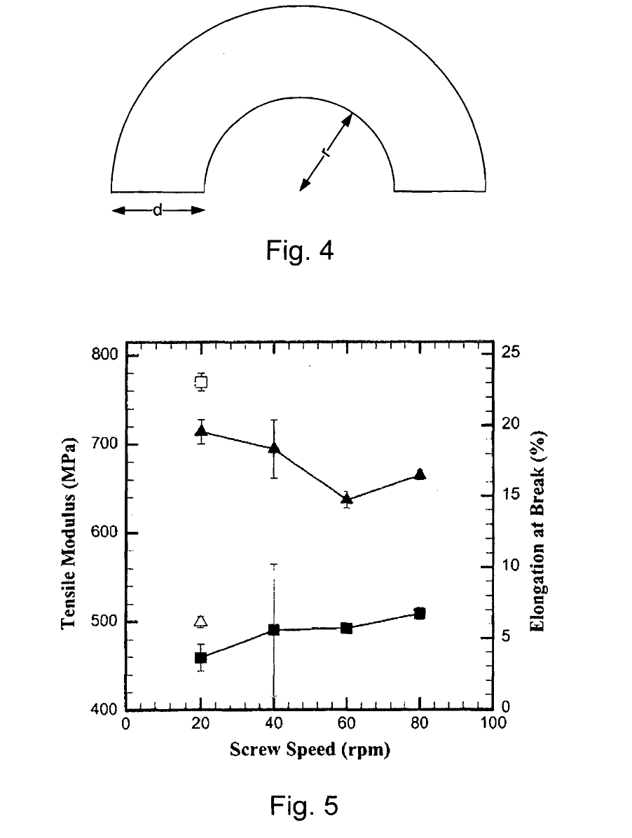

FIG. 4 shows a simple way to estimate the strain produced when a wire is bent through 180° in an arc of a specific radius.

One assumes the longitudinal center of the wire is unstrained, the outer edge is under tension while the inner edge is under compression.

Length difference between inner and outer edge=πd
Differential strain between inner and outer edge=πd/π(r+d/2)=2d/(2r+d)

If the wire is bent through a diameter six times the diameter of the wire (r=3d), the maximum strain is approximately 30%, which must not exceed the breaking strain of the insulation. Pure LCPs will not meet this requirement.

Here, it is proposed to use blended liquid crystal polymers for use as wire insulations. The components of the blend are chosen so as to increase the strain at break while at the same time sufficiently retaining the desirable tensile and high temperature properties of LCPs. Additionally, the blended components can be chosen to make the blend inherently arc-track resistant.

Blending of two different LCPs, one with a high melting temperature and the other with a low melting temperature, has been used to achieve a blend with good molding properties and processability at low temperatures (Japanese Patent JP2007119639). LCPs and thermoplastics have been blended to achieve tensile strength and flexural strength greater than the corresponding properties of the constituent polymers (U.S. Pat. No. 6,221,962). Electrically conducting blends of LCP have also been proposed (U.S. Pat. No. 5,391,622).

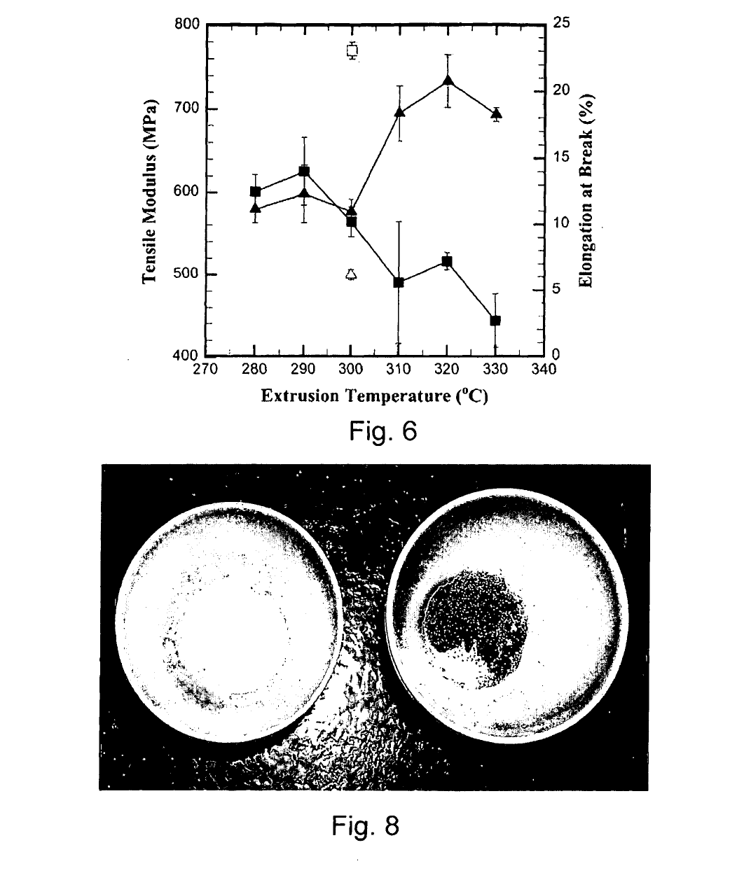

There are several reports in the literature on the blending of LCPs with other thermoplastics. The effect of blending on breaking strain and tensile strength of the LCP is critical. Son and Weiss (Son, 2001) have reported the results of reactively blending Vectra A950 LCP with low density polyethylene (LDPE). Reactive blends use compatibilizers, which are polymeric additives, that when added to a blend of immiscible polymers, modifies their interfaces and stabilizes the blend. The compatibilizer may chemically graft to one or both components of the blend and alter their surface interactions favorably. Son, et al used a partially neutralized sodium salt of polyethylene-co-ran-acrylic acid as a compatibilizer. FIG. 5 and FIG. 6 show enhanced elongation at break for blends of Vectra A LCP and LDPE (Son, 2001). A single screw extruder is used for blending—extrusion temperature and screw speed are varied to control properties. In FIG. 5, the screw speed at which the blend is extruded is varied while the compatibilizer preparation temperature is kept fixed at 310° C. The blends were extruded at 290° C. at 40 rpm in a single screw extruder. In FIG. 6, the preparation temperature of the compatibilizer is varied while the screw speed is kept fixed at 40 rpm. (▴) elongation at break; (▪) tensile modulus; open symbols denote the uncompatibilized blend with the same ratio of TLCP/LDPE The blends were extruded at 290° C. and 40 rpm in a single-screw extruder. (▴) elongation at break; (▪) tensile modulus; open symbols denote the uncompatibilized blend with the same ratio of TLCP/LDPE The figures have discrete points marked by unfilled symbols that indicate modulus and strain at break values of un-compatibilized blends. By suitable choice of extrusion conditions the elongation at break can be increased to 20% for compatibilized blend.

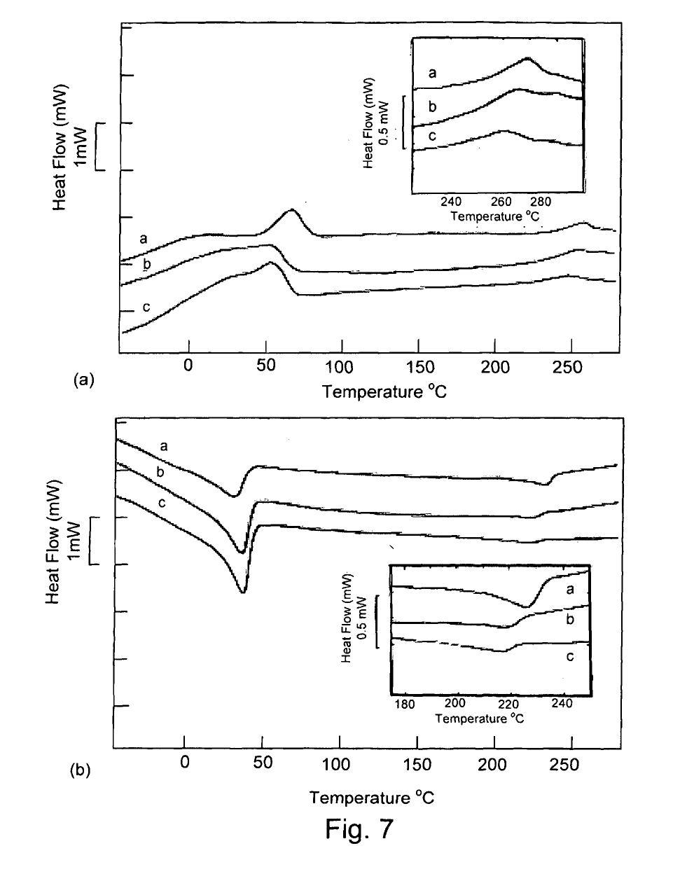

Another key issue is the effect of blending on the melting temperature of the LCP. FIG. 7 shows Differential Scanning Calorimetry (DSC) curves for a reactive blend of Vectra A LCP, with a melting temperature of 277° C., and an ethylene-co-acrylic acid ionomer compatibilizer (Zhang, 2000). Blends of the ionomers were prepared by melt mixing in a Brabender mixer at 300° C. The extent of grafting of monomer to LCP was changed by changing mixing time between 1 to 10 min. DSC curves for a 50/50% blend of Vectra A and monomer are shown in FIG. 7. Both heating and cooling curves show phase transitions at about 70° C. and 270° C., which are the melting points of the compatibilizer and LCP, respectively. Melting temperature of the LCP decreases only from 268° C. to 260° C. as mixing time increases from 3 to 10 min. Therefore, LCP blends can be developed that do not degrade the desirable high temperature properties of LCPs.

For harness applications, any electrical arcing event due to an electrical short, raises local insulation temperature for a short time and initiates some degree of combustion. Incomplete combustion during such an arcing event results in deposition of carbon char, which subsequently leads to arc-tracking. Therefore, one test for arc-track susceptibility of an insulation material is to expose it for short durations to high temperatures and look for carbon char formation on the surface.

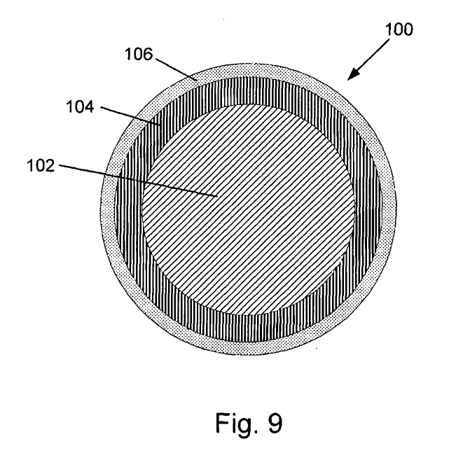

The following experiment was conducted to determine char formation for different polymers. One gram samples of A950 Vectra LCP and A430, which is a composite consisting of 70% A950 Vectra LCP and 30% Polytetrafluoroethylene (PTFE), were heated to 650° C. in alumina crucibles in air. After about 30 min. in the oven, the crucibles were removed and visually examined. The A950 crucible had a powdery black residue, probably carbon. The A430 crucible had almost no residue except for a very small quantity of white powder which was not carbon. Photographs of the two crucibles after heat exposure are shown in FIG. 8.

A desirable insulation would consist of a single extruded layer of LCP/fluoropolymer reactive blend, where a compatibilizer has been used to induce some degree of chemical bonding between the LCP and fluoropolymer components. However, note that the blend may not be reactive but a physical blend of LCP and fluoropolymer with no compatibilizer and still have desirable properties (Das, 2006, Dutta, 1993). Typically, the strain at break of the blended polymer would be somewhere between the breaking strains of the two constituents. The exact proportion of the two constituents in the blend would be chosen so as to optimize arc-track resistance and strain at break.

Choice of fluoropolymer for blending may be chosen from those listed in; namely, Perfluoroalkoxyethylene (PFA), Fluorinated Ethylene Propylene (FEP), and Ethylene tetrafluoroethylene (ETFE). They are desirable because they are extrudable so that the blend will also be extrudable, and also because their strain at break is very large so that the blended material will have a strain at break of higher than 5%.

One problem encountered with some extruded LCPs is poor resistance to abrasion since the LCP layer tends to separate into fibers when abraded. For LCP buffered optical cables we have increased abrasion resistance by extruding a thin layer of a thermoplastic, such as Nylon, over the LCP layer.

For wire harnesses, similarly, abrasion resistance can be increased by use of a secondary extruded thermoplastic layer. Nylon can be used, as above, but Nylon is a low temperature thermoplastic. To fabricate high temperature wire harness thermoplastics such as FEP (Fluorinated Ethylene Propylene), Tefzel™ (modified ethylene-tetrafluoroethylene) and PFA (Perfluoroalkoxyethylene) may be used for the anti-abrasion layer (See Table 2).

TABLE 2
Melting temperatures of some abrasion resistant thermoplasitcs

| Thermoplastic | Melting Temperature (° C.) |
|---|---|
| FEP (Fluorinated Ethylene Propylene) | 260 |
| Tefzel ™ (modified ethylene- | 267 |
| tetrafluoroethylene) | |
| PFA (Perfluoroalkoxyethylene) | 360-420 (grade dependant) |

The LCP blends of the invention are preferably extruded over electrical conductors using conventional extruding techniques. A typical wire structure is shown in FIG. 9 where it is designated generally at 100. Structure 100 comprises an elongated conducting wire 102 surrounded by a layer of insulation 102 comprising a blend of LCP and a thermoplastic. The insulation layer 102 is preferably, in turn, surrounded by an abrasion layer, preferably formed of a fluropolymer, to enhance resistance to abrasion. Wire gauges on which the blended insulation may be applied range from American Wire Gauge (AWG) 40 to AWG 5 corresponding to a wire diameter of 0.0031″ to 0.1819″. The applied thickness of the insulation layer may range from 0.001″ to 0.020″, and the thickness of the outside abrasion layer may range from 0.001″ to 0.010″.

Other variants of the invention will occur to those skilled in the art given its disclosure and teachings. For example, it is thoroughly possible to cross-head extrude flat, ribboned versions of cable harness in which two or more conducting wires reside side by side. Circular, rectangular, or other geometric architectures are also possible for cable arrangements in where the cable comprises more than one wire. In addition, LCP blended insulation layers may be used with polymeric electrically conducting wire. Additionally LCP blends may be extruded directly on the conductor or on top of other insulating layers that have already been applied to the conductor.

What is claimed is:

1. An electrically conducting wire structure comprising:
at least one elongated electrically conducting wire; and
a liquid crystal polymer and thermoplastic blended coating of insulation formed as a layer around said electrically conducting wire, said thermoplastic having properties so that said blended coating has a strain break at least 5% larger than said liquid crystal polymer would have acting alone.

2. The electrically conducting wire structure of claim 1 wherein said thermoplastic comprises a fluoropolymer.

3. The electrically conducting wire structure of claim 1 where said blended coating includes a compatibilizer so that said blended coating is a reactive blend.

4. The electrically conducting wire structure of claim 2 where said thermoplastic comprises a fluoropolymer and said blended coating includes a compatibilizer so that said blended coating is a reactive blend.

5. The electrically conducting wire structure of claim 1 further including an abrasion layer formed over the liquid crystal polymer coating to increase abrasion resistance.

6. The electrically conducting wire structure of claim 5 where the abrasion resistance layer is a fluoropolymer.

7. The electrically conducting wire structure of claim 1 wherein said blended coating of insulation is formed by cross-head extrusion.
